(19) United States
(12) Patent Application Publication
(10) Pub. No.: US 2005/0288442 A1
(43) Pub. Date: Dec. 29, 2005

(54) Polyolefin foams for footwear foam applications

(76) Inventors: Richard T. Chou, Hockessin, DE (US); Kye Hyun Kim, Seoul (KR); Wayne Curtis Whelchel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/157,893

(22) Filed: Jun. 21, 2005

Related U.S. Application Data
(60) Provisional application No. 60/581,493, filed on Jun. 21, 2004.

(51) Int. Cl. C08L 51/00

(52) U.S. Cl. 525/199

(57) ABSTRACT

A composition that can be used as foam composition is disclosed, which comprises or is produced from an ethylene acrylate copolymer, an acid copolymer or an ionomer of the acid copolymer or both, or combinations thereof, and optionally a soft ethylene polymer. The ethylene acrylate copolymer comprises repeat units derived from ethylene and at least one alkylacrylate. The acid copolymer comprises repeat units derived from ethylene and acrylic acid, methacrylic acid, or combinations thereof. The soft ethylene polymer comprises ethylene and an α-olefin, vinyl acetate, or combinations thereof.

This application claims priority to U.S. provisional application Ser. No. 60/581493, filed Jun. 21, 2004, the entire disclosure of which is incorporated herein by reference.

The invention relates to a polymer foam composition such as a crosslinked polymer foam composition and an article produced therefrom.

### BACKGROUND OF THE INVENTION

Polyolefinic materials encompass a variety of polymers ranging from semi-rigid polypropylene (PP) to soft ethylene polymers. They can be used to produce a variety of foam products. Most polyolefin foams are closed-cell foams, which are buoyant, resilient, tough, flexible, and resistant to chemicals and abrasion. Therefore, polyolefin foams are useful for packaging, construction, insulation, sports, leisure and footwear applications.

Copolymers of ethylene and vinyl acetate (EVA) have been widely used as base resin polymers in foam applications for many years. Crosslinked EVA foams, expanded with chemical blowing agents, provide an attractive balance of resilience, durability and other physical properties required for soling applications in footwear. These properties are provided at low density, which is desirable for lighter weight shoes, and at an attractive cost. EVA may present limitations in attaining a balance of softness (e.g., surface softness), low compression set, and high resilience. Also, as foam processes move more toward one-step injection molding, achieving balanced properties using EVA foam may become difficult.

Foams made from ethylene acrylate copolymers (also referred to as ethylene-acrylic acid ester copolymers), such as ethylene-methyl acrylate copolymer (E/MA) with high MA content, are generally soft, have low density and are highly resilient.

E/MA foam may be weak in mechanical properties, such as tear strength and tensile strength, and may be difficult to crosslink.

There is a continued need to develop new products to expand the performance window of known polyolefin foams, such as the foam footwear market, to reduce costs, and to improve manufacturing process. It is also desirable to improve the crosslinking and mechanical properties while retaining the inherent merits of E/MA foams.

### SUMMARY OF THE INVENTION

The invention provides a composition comprising (a) an ethylene acrylate copolymer, (b) an acid copolymer or ionomer of the acid copolymer, and, optionally, (c) a soft ethylene polymer.

The invention also provides a crosslinked polymer foam composition comprising: (a) about 50 to about 95 wt %, or about 70 to about 90 wt %, or about 60 to about 80 wt %, ethylene acrylate copolymer, (b) about 5 to about 50 wt % or about 10 to about 30 wt % acid copolymer or ionomer, and optionally (c) about 0 or about 5 to about 40 wt % soft ethylene polymer wherein all weight percentages are based on the combined weight of (a)+(b)+(c).

The invention further provides a foam article made from the compositions disclosed herein as well as a midsole or insole for footwear.

### DETAILED DESCRIPTION OF THE INVENTION

“Copolymer” means a polymer comprising repeat units derived from two or more monomers or comonomers and thus including terpolymer or tetrapolymer.

Ethylene acrylate copolymer can comprise repeat units derived from ethylene and an ester of unsaturated carboxylic acid such as (meth)acrylate or C₁ to C₈ alkyl acrylate, or combinations of two or more thereof. “(Meth)acrylate”, refers to acrylate, alkyl acrylate, methacrylate, or combinations of two or more thereof.

Examples of alkyl acrylates include methyl acrylate, ethyl acrylate and butyl acrylate. For example, “ethylene/methyl acrylate (E/MA)” means a copolymer of ethylene and methyl acrylate (MA); “ethylene/ethyl acrylate (E/EA)” means a copolymer of ethylene and ethyl acrylate (EA); “ethylene/butyl acrylate (E/BA)” means a copolymer of ethylene and butyl acrylate (BA); and includes both n-butyl acrylate and iso-butyl acrylate; and combinations of two or more thereof.

Copolymers of ethylene and an acrylate are well known. “Ethylene acrylate copolymers” may also be referred to as ethylene-acrylic acid ester copolymers. They can be manufactured from two high-pressure free radical processes: tubular processes or autoclave processes. The difference in ethylene acrylate copolymers made from the two processes is described in, e.g., “High flexibility E/MA made from high pressure tubular process.” Annual Technical Conference—Society of Plastics Engineers (2002), 60th (Vol. 2), 1832-1836. The ethylene acrylate copolymer produced from the tubular process is preferred in the invention herein.

Alkyl acrylate comonomer incorporated into ethylene acrylate copolymer can vary from 0.01 or 5 up to as high as 40 weight % of the total copolymer or even higher such as from 5 to 30, or 10 to 25, wt %.

Ethylene acrylate copolymer can also include another comonomer such as carbon monoxide, glycidyl acrylate, glycidyl methacrylate, and glycidyl vinyl ether, or combinations of two or more thereof.

The ethylene acrylate copolymer may contain about 15 to about 40, or about 18 to about 35, wt % of acrylate comonomer. Increasing acrylate comonomer may improve the elastomeric properties and increase the tackiness of the copolymer. The ethylene acrylate copolymer may have a melt index (MI) of from about 0.1 to about 100, or about 0.5 to about 20, g/10 min, measured with ASTM D-1238, condition E (190° C., 2160 gram weight).

An acid copolymer can comprise repeat units derived from ethylene and an unsaturated carboxylic acid such as (meth)acrylic acid, maleic acid, fumaric acid, maleic anhydride, fumaric anhydride, maleic acid monoester, fumaric acid monoester, or combinations of two or more thereof. “(Meth)acrylic”, refers to acrylic acid, methacrylic acid, or combinations thereof. For example, “ethylene/methacrylic acid (E/MAA)” means a copolymer of ethylene (E) and methacrylic acid (MAA); “ethylene/acrylic acid (E/AA)” means a copolymer of ethylene and acrylic acid (E/AA). Examples of more than one comonomer are also included. For example “ethylene/isobutyl acrylate methacrylic acid (E/iBA/MAA)” means a terpolymer of ethylene (E), iso-butyl acrylate (iBA) and methacrylic acid (MAA). The acid copolymer can comprise about 1 to about 10 mole % of repeat units derived from an acid or anhydride or monoester of a diacid.

(Meth)acrylic acid comonomer incorporated into ethylene acid copolymer can vary from 0.01 or 5 up to as high as 30 wt % of the total copolymer or even higher such as from 5 to 25, or 10 to 25, wt %. The acid copolymer may also contain up to 25 wt % of an alkyl acrylate having an alkyl group with a C₁-C₈ alkyl acrylate.

Ethylene acid copolymers and their methods of preparation are well known in the art such as disclosed in U.S. Pat. Nos. 3,264,272, 3,404,134, 3,355,319 and 4,321,337. Commercial acid copolymers suitable for use in the invention herein are available from various sources, including the E. I. du Pont de Nemours and Company, Wilmington, Del. (DuPont) under the trademark Nucrel®.

Ethylene acid copolymers may be direct copolymers or graft copolymers. ‘Direct copolymer’ is a copolymer made by polymerization of monomers together, at the same time, as distinct from a graft copolymer where a monomer is polymerized on an existing polymer chain. When direct or graft acid copolymers have from about 0.0001 to about 90 percent of the carboxylic acid groups ionized by neutralization with metal ions, these are termed ionic copolymers, or “ionomers”, which have solid state properties characteristic of crosslinked polymers and melt-fabricability characteristics of uncrosslinked thermoplastic polymers. Commercial ionomers include Surlyn® ionomers from DuPont.

The acid copolymer or ionomer is preferably present in an amount ranging from about 5% to about 50% by weight, more preferably from about 10% to about 30% by weight, and most preferably about 8% to about 15% by weight. The acid copolymer preferably contains about 4 to about 25 weight percent of acid, and more preferably about 8 to about 15 weight percent of acid. The acid copolymer may have a melt index of from 0.1 to 500, preferably 1 to 100, most preferably 1 to 30 grams/10 minutes.

The ionomers may have a melt index of from about 0.1 to 100, or about 0.5 to 20 g/10 minutes, be derived from an acid copolymer having about 4 to about 25, or about 8 to about 15, wt % of acid, and have a degree of neutralization ranging from about 20 to 70 wt %.

Soft ethylene polymer comprises copolymer of ethylene and an α-olefin copolymer, copolymer of ethylene and vinyl acetate, or combinations thereof. Soft ethylene polymer can be made by any processes well known in the art, including the use of Ziegler Natta catalysts, metallocene catalysts, and other catalysts useful in “low pressure” polymerization processes. EVA copolymers may be made in “high pressure” polymerization processes using, for example, free radical initiators. Because these processes are well known, the disclosure of which is omitted for the interest of brevity.

A soft ethylene polymer includes linear low-density polyethylene (LLDPE), metallocene-catalyzed polyethylene (MPE), EVA copolymer, or combinations of two or more thereof. MPE can have a density less than about 0.89 and a melt index (MI) of from about 0.1 to 100, or about 0.5 to 30, g/10 minutes, as measured using ASTM D-1238, condition E (190° C., 2160 gram weight). EVA may comprise repeat units derived from at least about 15 wt %, or about 15 to about 35 wt %, or about 18 to about 30 wt %, vinyl acetate. The ethylene soft polymer may have a melt index (MI) of from about 0.1 to 100, or about 0.5 to about 20 (for EVA, about 0.5 to 30), g/10 minutes, as measured using ASTM D-1238, condition E (190° C., 2160 gram weight). EVA is available from DuPont.

MPE is also referred to as metallocene polyethylene copolymer, copolymer of ethylene and an α-olefin monomer using a metallocene catalyst. MPE technology is capable of making lower density MPE with high flexibility and low crystallinity. MPE technology is described in, for example, U.S. Pat. Nos. 5,272,236, 5,278,272, 5,507,475, 5,264,405, and 5,240,894. MPE copolymers include Dow Chemical Co under AFFINITY®, DuPont-Dow under the ENGAGE®, and Exxon Mobile under the EXACT® and PLASTOMER®.

The composition can also be a crosslinked foam composition including desired properties such as high resiliency, lower compression set, and most importantly foam softness. For example, foams derived from ethylene-methyl acrylate copolymer (E/MA) with high MA content may be generally soft, have low density, and are highly resilient. These properties are desirable in foam footwear applications, specifically for midsoles and insoles. The mechanical properties of E/MA foams, such as split tear resistance and tensile strength, may not be as desirable for maintaining long durability. As the foam density decreases, the mechanical properties of E/MA may deteriorate. Blending E/MA with an ethylene acid copolymer may enhance E/MA mechanical properties thereby making the E/MA foam useful for midsole foam applications.

The foam composition can comprise about 95 to about 40 wt %, about 90 to about 50 wt %, or about 80 to about 60 wt % of an ethylene acrylate copolymer such as ethylene-methyl acrylate, ethylene-butyl acrylate, or ethylene-ethyl acrylate.

The soft ethylene polymer can be present in a range from about 0 to about 40%, or about 5% to about 30%, or about 10% to 30%, by weight.

The composition may additionally comprise other polymers, different from those disclosed above in an amount ranging from about 0.01 to about 15 or 0.5 wt % to about 10 wt % of the composition including LDPE, LLDPE, or combinations thereof.

The composition may also comprise a free radical initiator or crosslinking agent including organic peroxides such as dialkyl organic peroxides ranging from about 0.2 to about 1.5% (i.e., about 0.2 to about 1.5 parts by weight of peroxide for each 100 parts by weight of the composition). Examples of organic peroxides include 1,1-di-t-butyl peroxy-3,3,5-trimethylcyclohexane, t-butyl-cumyl peroxide, dicumyl-peroxide, 2,5-dimethyl-2,5-di(tertiary-butyl-peroxyl)hexane, 1,3-bis(tertiary-butyl-peroxyl-isopropyl) benzene, or combinations of two or more thereof.

The composition may also comprise about 0.001 to about 1 wt % of a co-curing agent including trimethyl propane triacrylate (and similar compounds), N,N-m-phenylenedimaleimide, triallyl cyanuate, or combinations of two or more thereof.

The foam composition can also comprise, about 0.001 or about 0.2 to about 10% by weight of the composition, a blowing agent. A blowing agent can be a chemical blowing agent or a physical blowing agent. Physical blowing agents are halocarbons, volatile organic compounds, or non-flammable inert atmosphere gases. Chemical blowing agents include azodicarbonamide (ADCA), dinitroso-pentamethylene-tetramine (DPT), P-toluene sulfonyl hydrazide, and p.p′-oxybis(benzenesulfonyl hydrazide). To tailor expansion-decomposition temperature and foaming processes, a blowing agent may also be a mixture of blowing agents or of blowing agents with a blowing aid. For example, Vinyl for AK-2 (manufactured by Eiwa Kasei Chemical Co., Japan) is a mixture of ADCA and DPT. Uniroyal Chemical Celogen 765 is a modified ADCA.

The composition may also include about 1 to about 10% or about 2 to 6% by weight (of the composition) an activator (for the blowing agent) to lower the decomposition temperature/profile of blowing agents. A blowing agent activator can be one or more metal oxides, metal salts, or organometallic complexes. Examples include ZnO, Zn stearate, MgO, or combinations of two or more thereof.

Other additives may include any additives typically used in similar crosslinked polymer compositions and may include a pigment (TiO₂ and other compatible colored pigments), an adhesion promoter (to improve adhesion of the expanded foam to other materials), a filler (e.g., calcium carbonate, barium sulfate, and/or silicon oxide), a nucleating agent (pure form or concentrate form, e.g., CaCO₃ and/or SiO₂), rubber (to improve rubber-like elasticity, such as natural rubber, SBR, polybutadiene, and/or ethylene propylene terpolymer), a stabilizer (e.g., antioxidants, UV absorbers, and/or flame retardants), and a processing aid (e.g., Octene R-130 manufactured by Octene Co., Taiwan).

The foam composition may be produced by a number of methods, such as compression molding, injection molding and hybrids of extrusion and molding. The process can comprise mixing the polymers and crosslinking agents under heat to form a melt, along with blowing agents and other typical additives, to achieve a homogeneous compound. The ingredients may be mixed and blended by any means known in the art such as with a Banbury, intensive mixers, two-roll mill, and extruder. Time, temperature, shear rate may be regulated to ensure optimum dispersion without premature crosslinking or foaming. A high temperature of mixing may result in premature crosslinking and foaming by decomposition of peroxides and blowing agents. An adequate temperature may be necessary to insure good mixing of the polymers, e.g., E/MA and E/MAA (and/or MPE), and the dispersion of other ingredients. E/MA and E/MAA can form a uniform blend when blended at temperatures of about 80 to about 150° C. or about 80° C.-130° C. The upper temperature limit for safe operation may depend on the onset decomposition temperatures of peroxides and blowing agents employed.

Optionally, polymers such as E/MA and E/MAA can be melt-blended in an extruder at a temperature up to about 250° C. to allow potentially good mixing. The resultant mixture can be then compounded with the ingredients disclosed above.

After mixing, shaping can be carried out. Sheeting rolls or calendar rolls are often used to make appropriately dimensioned sheets for foaming. An extruder may used to shape the composition into pellets.

Foaming can be carried out in a compression mold at a temperature and time to complete the decomposition of peroxides and blowing agents. Pressures, molding temperature, and heating time may be controlled. Foaming can be carried out in an injection molding equipment by using foam composition in pellet form. The resulting foam can be further shaped to the dimension of finished products by any means known in the art such as by thermoforming and compression molding.

The resulting polymer foam composition can be substantially closed cell and useful for a variety of articles, e.g., footwear application including midsoles or insoles.

The invention can be illustrated by the following examples, which are not meant to limit the scope of the invention.

### EXAMPLES

Test Methods:

Foam rebound resilience test was measured according to ASTM D 3574. The hardness of the foam was measured on a Type C (spring-type) hardness tester of ASKER, Japan according to ASTM D2240. Compression set was measured according to ASTM D3754 at the conditions of 50° C./6 hours. Split-tear was measured according to ASTM D3574. Compression strength testing was performed on an Instron Universal testing machine fitted with a compression cage deforming the foam samples at a uniform rate of 0.05 in./min. The stress required to produce compression strain up to 50% was determined. The compressive stress was determined as the force per unit area based on the original foam cross-section.

Sample Preparation:

Polymers and chemicals were weighed on a Mettler PC 2000 balance followed by mixing. E/MA and E/MAA were charged into a Banbury (Bolling internal mixer). The mixer had a capacity of 1100 cc. The resins were fluxed at a temperature from 150° F.-200° F. After 1-2 minutes the remaining ingredients (except peroxide and blowing agent) were incorporated for 4-5 minutes. Then peroxide, blowing agents and other ingredients were added next. The mixing continued for 4-5 additional minutes, keeping the temperature under 200° F. The compound was discharged and transferred to a 6 inch×13 inch Bolling OX two-roll mill. The mill was oil heated and set for a temperature of 150° F. Batch size for the mill was about 500 to 1200 g. Maximum speed was 35 feet per minute. Roll gap was adjusted to produce sheets for sample cutting (150 to 300 mils).

Samples were cut on a Hudson Hydraulic Clicker, using a 3 inch×3 inch die, and weighed to 90 g. The foaming process consisted of putting the 90 g sample into a 3 inch×3 inch beveled mold with an overall measurement of 6×6×½ inches. This was put between two 9 inch by 10 inch by ¼ inch aluminum plates. The plates and sample were placed into an automatic PHI press. Samples were typically in the press for 10-30 minutes at a temperature of about 155° C.-185° C. under pressure of about 3300 lbs. The foam was formed instantaneously when the mold was opened at the end of the molding cycle.

Results shown in the following table show that foams of ethylene-methyl acrylate copolymers (Comparable Examples A, B and C) exhibited softness that provided comfort in wearing and excellent resilience, but exhibited lower mechanical properties. All Comparative Examples showed low split-tear strength and compression strength. Compression strength determined the load bearing capability of foam at a given density.

Comparative Example B and Comparative Example C containing higher peroxide content, while Comparative Example C also containing co-curing agent, showed improved compression set, but further deteriorated split-tear

As seen in the Table below, the E/MA foams modified with a minor component of acid copolymer showed higher tear strength and compression strength. Example 3, containing a soft E/nBA/MAA terpolymer, also rendered an enhancement in tear strength. All foams retained softness, which was an attractive feature for E/MA foams. Example 4, containing both acid copolymer and MPE, appeared to achieve balanced properties by attaining high resilience, desirable softness and mechanical strength. All Examples show desired balance of properties for footwear applications.

| | Foaming | Foam | Foam | | Split Tear | Compression | Rebound |
|---|---|---|---|---|---|---|---|
| | Condition | Density | Hardness | Compression | Strength | Strength | Resilience |
| Example¹ | (C/min) | (g/cc) | (Asker C) | Set (%) | (kg/cm) | (PSI) | (%) |
| Comp Ex A | 165/20 | 0.122 | 30 | 59 | 2.4 | 22 | |
| | 175/10 | 0.118 | 29 | 59 | 2.6 | | 54 |
| Comp Ex B | 165/20 | 0.156 | 34 | 48 | 1.9 | 34.5 | 51 |
| | 175/10 | 0.132 | | 52 | 1.8 | | 54 |
| Comp Ex C | 165/20 | 0.28 | 47 | 39 | 1.6 | | |
| | 175/10 | 0.166 | 42 | 42 | 1.4 | | |
| Ex 1 | 165/20 | 0.14 | 38 | 51 | 3.6 | 35 | 44 |
| | 175/10 | 0.126 | | 57 | 2.3 | | 46 |
| Ex 2 | 165/20 | 0.146 | 40 | 50 | 3.2 | 39.4 | 40 |
| | 175/10 | 0.133 | | 54 | 3.1 | | 44 |
| Ex 3 | 165/20 | 0.139 | 27 | 55 | 3.2 | 28.3 | 47 |
| | 175/10 | 0.126 | | 62 | 3 | | 48 |
| Ex 4 | 155/20 | 0.155 | 48 | 51 | 3.7 | 43.7 | 48 |
| | 165/20 | 0.156 | 50 | 52 | 3 | | 50 |

¹Peroxide present was Comparative Example A (0.8 pph, parts per 100 parts of the composition) and all other Comparative Examples and Examples were each 1 pph.

### Composition of the Examples

All examples used E/MA (ethylene/methyl acrylate copolymer containing 24 wt % MA with a MI of 2.0, DuPont) and Celogen 765 (from Uniroyal Co.) as blowing agent.

### Comparative Example A

E/MA, 832 g; DCP, 6.7 g; blowing agent, 30 g; Zn stearate, 8.0 g; ZnO, 8.0 g; Stearic acid, 4.0 g; CaCO₃, 25 g.

### Comparative Example B

E/MA, 832 g; DCP, 8.5 g; blowing agent, 30 g, Zn stearate, 4.0 g; CaCO3, 25 g

### Comparative Example C

E/MA, 832 g; DCP, 8.5 g; triallyl cyanuate, 4.5 g; blowing agent, 25 g; Zn stearate, 4.0 g; Stearic acid, 4.0 g; CaCO₃, 25 g.

### Example 1

E/MA, 707.3 g; E/MAA (ethylene/methacrylic acid copolymer containing 9 wt % of methacrylic acid with a MI of 3.0, DuPont), 124.3 g; DCP, 8.5 g, blowing agent, 30 g; Zn stearate, 4.0 g; CaCO3, 25 g.

### Example 2

E/MA, 707.3 g, E/MAA (same as Example 1), 124.3 g, DCP, 8.5 g, TAC (triallyl cyanuate), 4.5 G; blowing agent, 30 g, Zn stearate, 4.0 g, CaCO3, 25 g.

### Example 3

E/MA, 707.3 g, E/nBA/MAA (terpolymer of ethylene, n-butyl acrylate and methacrylic acid containing 23 wt % of n-butyl acrylate and 9 wt % of methacrylic acid with a MI of 30, DuPont), 124.3 g; DCP, 8.5 g; blowing agent, 30 g, Zn stearate, 4.0 g, CaCO3, 25 g.

### Example 4

E/MA, 442 g, MPE (a copolymer of ethylene and 1-octene with a density of 0.87 g/cc and a MI of 1.0, from DuPont Dow Elastomers), 265 g, E/MAA (same as Example 1), 124.3 g, DCP, 8.5 g; blowing agent, 30 g, Zn stearate, 6 g, Stearic acid, 9.6 g.

1. A composition comprising an ethylene acrylate copolymer, an acid copolymer or an ionomer of the acid copolymer or both, and optionally a soft ethylene polymer wherein the ethylene acrylate copolymer comprises repeat units derived from ethylene and at least one alkylacrylate; the acid copolymer comprises repeat units derived from ethylene and (meth)acrylic acid, maleic acid, fumaric acid, maleic anhydride, fumaric anhydride, maleic acid monoester, fumaric acid monoester, or combinations of two or more thereof; and the soft ethylene polymer comprises copolymer of ethylene and an α-olefin, copolymer of ethylene and vinyl acetate, or combinations thereof.

2. The composition of claim 1 wherein the ethylene acrylate copolymer comprises repeat units derived from ethylene and methyl acrylate, ethyl acrylate, butyl acrylate, or combinations of two or more thereof.

3. The composition of claim 1 wherein the acid copolymer comprises repeat units derived from ethylene and (meth)acrylic acid, an ionomer of the acid copolymer, or combinations thereof.

4. The composition of claim 2 wherein the acid copolymer comprises repeat units derived from ethylene and (meth)acrylic acid.

5. The composition of claim 4 wherein the soft ethylene polymer comprises repeat units derived from ethylene and α-olefin.

6. The composition of claim 2 wherein the soft ethylene polymer comprises a metallocene catalyst-produced polyethylene having a density less than about 0.89, an ethylene-vinyl acetate copolymer comprising at least about 15 weight % vinyl acetate, or combinations thereof.

7. The composition of claim 1 further comprising about 0.2 to about 1.5 wt % of a crosslinking agent, about 0.5 to about 10 wt % of a blowing agent(s), about 0.1 to about 10 wt % of an activator for the blowing agent, and optionally 0.1 to 1 wt % of a co-curing agent.

8. A composition comprising or derived from about 50 to about 95 wt % ethylene acrylate copolymer, about 5 to about 50 wt % acid copolymer or an ionomer or the acid copolymer or combinations thereof, and about 0 to about 40 wt % soft ethylene polymer wherein the ethylene acrylate copolymer comprises repeat units derived from ethylene and methyl acrylate, ethyl acrylate, or combinations thereof; the acid copolymer comprises repeat units derived from ethylene and (meth)acrylic acid, an ionomer of the acid copolymer, or combinations of two or more thereof; and the soft ethylene polymer comprises copolymer of ethylene and an α-olefin, copolymer of ethylene and vinyl acetate, or combinations thereof.

9. The composition of claim 8 wherein the ethylene acrylate copolymer comprises repeat units derived from ethylene and methyl acrylate; the acid copolymer comprises repeat units derived from ethylene and (meth)acrylic acid; and the soft ethylene polymer comprises a very low density PE, metallocene catalyst-produced polyethylene, an ethylene-vinyl acetate copolymer, or combinations of two or more thereof.

10. The composition of claim 9 wherein the composition comprises or is derived from about 70 to about 90 wt % of the ethylene acrylate copolymer, about 10 to about 30 wt % of the acid copolymer or an ionomer of the acid copolymer or combinations thereof, and about 0 to about 40 wt % of the soft ethylene polymer.

11. The composition of claim 8 wherein the ethylene acrylate copolymer comprises repeat units derived from methyl acrylate.

12. The composition of claim 11 wherein the acid copolymer comprises repeat units derived from ethylene and methacrylic acid, acrylic acid, or combinations thereof.

13. The composition of claim 12 wherein the acid copolymer comprises repeat units derived from methacrylic acid.

14. The composition of claim 13 comprising the soft ethylene polymer.

15. The composition of claim 14 wherein the soft ethylene polymer is a metallocene catalyst-produced polyethylene having a density less than about 0.89, an EVA comprising repeat units derived from at least about 15 weight % vinyl acetate.

16. The composition of claim 15 wherein the soft ethylene polymer is the metallocene catalyst-produced polyethylene.

17. The composition of claim 15 wherein the ethylene acrylate copolymer comprises about 15 to about 40 wt % methyl acrylate.

18. The composition of claim 17 additionally comprising a polymer including a low density polyethylene, a linear low density polyethylene, or combinations thereof.

19. An article comprises or produced from a composition wherein the article includes foam, a midsole for footwear, insole for footwear, or combinations of two or more thereof and the article is as recited in claim 1.

20. The article of claim 19 wherein the article is a midsole for footwear, an insole for footwear, or both.
